(19) United States
(12) Patent Application Publication
(10) Pub. No.: US 2010/0119858 A1
(43) Pub. Date: May 13, 2010

(54) TINTED CLEAR COATINGS FOR WOOD

(75) Inventors: Johannes Benkhoff, Basel (CH); Wolfgang Peter, Neuenburg am Rhein (DE); Christian Marcus Schaller, Basel (CH)

Correspondence Address: Ciba Corporation;Patent Department, 540 White Plains Road, P.O. Box 2005, Tarrytown, NY, 10591, US

(73) Assignee: CIBA CORPORATION, Tarrytown, NY (US)

(21) Appl. No.: 12/594,348

(22) PCT Filed: Apr. 16, 2008
(86) PCT No.: PCT/EP08/54572

§ 371 Date: Oct. 2, 2009

(30) Foreign Application Priority Data
Apr. 25, 2007 (EP) 07106939.7

(51) Int. Cl. B32B 21/04; B05D 3/00

(52) U.S. Cl. 428/537.1; 427/160

(57) ABSTRACT

The present invention pertains to tinted clear coating for wood comprising: a) an un-tinted clear coating layer and b) at least one tinted clear coating layer and to a process for obtaining such tinted clear coating for wood.

The present invention pertains to tinted clear coating for wood comprising (a) an un-tinted clear coating layer and (b) at least one tinted clear coating layer and to a process for obtaining such tinted clear coatings for wood.

Tinted clear coatings for wood are known in the art, for instance W. Stenzel, Kunstharze Hoechst—Untersuchungenüber den Einfluss von UV-Licht auf die Besfändigkeit von Holzlasuren auf Dispersionsbasis, Kapitel 9, Sonderdruck aus Themenband Umwelteinfüsse auf Oberflächen, expert Verlag, Ehningen, 1989, S. 144-157; S. R. Blackburn, B. J. Meldrum, The use of fine particle titanium dioxide for UV protection in wood finishes, Farg Och Lack Scandinavia 9, 1991, S. 192-196; or F. Finus, Farbe and Lack (1975), 81 (7), 604-607; but in contrast to the present invention, the coating layer adhereing to wood is a tinted clear coating layer.

For instance, the tinted clear coating for wood according to this invention shows an increased color brilliance. Moreover, for example, the tinted clear coating for wood shows an increased lightness. In particular, the tinted clear coating for wood shows an increased lightness and an increased color brilliance. Additionally, for example, the tinted clear coating for wood shows an enhanced accentuation of three-dimensional structure of wood grains.

An embodiment of the present invention is a tinted clear coating for wood, wherein the wood coating comprises the following layers
(a) at least one un-tinted clear coating layer adhering to a wood substrate comprising at least one binder;
(b) at least one tinted clear coating layer adhering to the un-tinted clear coating layer (a) and comprising at least one binder and at least one colorant selected from the group consisting of dyes and pigments and combinations thereof.

A tinted clear coating is to be understood, that it is neither completely transparent and colourless as an un-tinted clear coating nor completely opaque as a typical pigmented coating. A tinted clear coating is transparent and coloured or semi-transparent and coloured.

Preferably, the un-tinted clear coating layer or un-tinted clear coating composition is substantially free of any colorants, most preferably does not comprise any colorants (e.g. pigments or dyes).

A coating layer is to be understood as a film forming layer. For instance, a coating layer is based on organic binders (e.g. modified natural substances or synthetic resins), which when applied to the wood substrate produces a cohesive, virtually water-impermeable (non-absorbent), protective and possibly decorative film. So for instance, the un-tinted clear coating (a) adhering to a wood substrate does not penetrate into the wood pores of the surface of the wood. For instance, the coating compositions comprise at least 15 wt-% binder, preferably at least 16 wt-% binder, especially at least 20 wt-% binder based on the weight of the coating composition. For instance, the coating layers describes herein are made of coating compositions comprising the above amount of binder.

Preferably, the tinted clear coating for wood comprises (a) one or two un-tinted clear coating layers and (b) one tinted clear coating layer, more preferably, the tinted clear coating for wood does not comprise any other coating layers than layers (a) and (b).

A preferred embodiment of the present invention is a tinted clear coating for wood, additionally comprising
(c) at least one un-tinted clear coating layer adhering to the tinted clear coating layer (b) and comprising at least one binder;
   and optionally
(d) at least one tinted clear coating layer adhering to the un-tinted clear coating layer (c) and comprising at least one binder and at least one colorant selected from the group consisting of dyes and pigments and combinations thereof.

Preferably, the coating layer (a) is directly next to the wood surface, the coating layer (b) is directly next to the coating layer (a), if present, the coating layer (c) is directly next to the coating layer (b) and the coating layer (d) is directly next to the coating layer (c).

For instance, the coating layer (d) is the top coating layer, i.e. there is not another coating layer on top of the coating layer (d).

For instance, every coating layer and every coating composition comprises a binder.

The binder can in principle be any binder which is customary in industry, for example those described in Ullmann's Encyclopedia of Industrial Chemistry, 5th Edition, Vol. A18, pp. 368-426, VCH, Weinheim 1991. In general, it is a film forming binder based on a thermoplastic or thermosetting resin, predominantly on a thermosetting resin. Examples thereof are alkyd, acrylic, acrylic alkyd, polyester, phenolic, melamine, epoxy and polyurethane resins and mixtures thereof.

The binder can be a ambient temperature curable or hot-curable binder; the addition of a curing catalyst may be advantageous. Suitable catalysts which accelerate curing of the binder are described, for example, in Ullmann's Encyclopedia of Industrial Chemistry, Vol. A18, p. 469, VCH Verlagsgesellschaft, Weinheim 1991.

Examples of coatings compositions containing specific binders are:

1. paints based on ambient- or hot-crosslinkable alkyd, acrylate, polyester, epoxy or melamine resins or mixtures of such resins, if desired with addition of a curing catalyst;
2. two-component polyurethane paints based on hydroxyl-containing acrylate, polyester or polyether resins and aliphatic or aromatic isocyanates, isocyanurates or polyisocyanates;
3. one-component polyurethane paints based on blocked isocyanates, isocyanurates or polyisocyanates which are deblocked during baking, if desired with addition of a melamine resin;
4. one-component polyurethane paints based on a trisalkoxycarbonyltriazine crosslinker and a hydroxyl group containing resin such as acrylate, polyester or polyether resins;
5. one-component polyurethane paints based on aliphatic or aromatic urethaneacrylates or polyurethaneacrylates having free amino groups within the urethane structure and melamine resins or polyether resins, if necessary with curing catalyst;
6. two-component paints based on (poly)ketimines and aliphatic or aromatic isocyanates, isocyanurates or polyisocyanates;
7. two-component paints based on (poly)ketimines and an unsaturated acrylate resin or a polyacetoacetate resin or a methacrylamidoglycolate methyl ester;
8. two-component paints based on carboxyl- or amino-containing polyacrylates and polyepoxides;
9. two-component paints based on acrylate resins containing anhydride groups and on a polyhydroxy or polyamino component;
10. two-component paints based on acrylate-containing anhydrides and polyepoxides;
11. two-component paints based on (poly)oxazolines and acrylate resins containing anhydride groups, or unsaturated acrylate resins, or aliphatic or aromatic isocyanates, isocyanurates or polyisocyanates;
12. two-component paints based on unsaturated polyacrylates and polymalonates;
13. thermoplastic polyacrylate paints based on thermoplastic acrylate resins or externally crosslinking acrylate resins in combination with etherified melamine resins;
14. paint systems based on siloxane-modified or fluorine-modified acrylate resins.

For instance, the binder is a binder for surface coatings, especially a binder for top coatings. Examples of such binders are an alkyd resin, a polyester resin, an acrylic resin, an epoxy resin, a polyurethane resin, a melamine/formaldehyde resin, a urea/formaldehyde resin, a blocked isocyanate resin and combinations thereof, especially an acrylic resin, a polyurethane resin, a blocked isocyanate resin and combinations thereof, in particular a polyurethane resin.

Possible drying catalysts or curing catalysts are, for example, organometallic compounds, amines, amino-containing resins and/or phosphines. Examples of organometallic compounds are metal carboxylates, especially those of the metals Pb, Mn, Co, Zn, Zr or Cu, or metal chelates, especially those of the metals Al, Ti or Zr, or organometallic compounds such as organotin compounds.

Examples of metal carboxylates are the stearates of Pb, Mn or Zn, the octoates of Co, Zn or Cu, the naphthenates of Mn and Co or the corresponding linoleates, resinates or tallates.

Examples of metal chelates are the aluminium, titanium or zirconium chelates of acetylacetone, ethyl acetylacetate, salicylaldehyde, salicylaldoxime, o-hydroxyacetophenone or ethyl trifluoroacetylacetate, and the alkoxides of these metals.

Examples of organotin compounds are dibutyltin oxide, dibutyltin dilaurate or dibutyltin dioctoate.

Examples of amines are, in particular, tertiary amines, for example tributylamine, triethanolamine, N-methyldiethanolamine, N-dimethylethanolamine, N-ethylmorpholine, N-methylmorpholine or diazabicyclooctane (triethylenediamine) and salts thereof. Further examples are quaternary ammonium salts, for example trimethylbenzylammonium chloride.

Amino-containing resins are simultaneously binder and curing catalyst. Examples thereof are amino-containing acrylate copolymers.

The curing catalyst used can also be a phosphine, for example triphenylphosphine.

The coatings compositions can also be radiation-curable coating compositions. In this case, the binder essentially comprises monomeric or oligomeric compounds containing ethylenically unsaturated bonds, which after application are cured by actinic radiation, i.e. converted into a crosslinked, high molecular weight form. Where the system is UV-curing, it generally contains a photoinitiator as well. Corresponding systems are described in the abovementioned publication Ullmann's Encyclopedia of Industrial Chemistry, 5th Edition, Vol. A18, pages 451-453.

Wood which can be coated according to the invention can be shaped wooden bodies with extensive surfaces, for example wooden planks, plywood and chipboard, which may be veneered, carved wooden objects, and wooden sections glued, nailed or screwed together to give, for example, furniture. For example, wood is to be understood to include veneered wood.

All customary types of wood can be used, for example pine, spruce, fir, oak, ash, beech, maple, walnut tree, pear tree, teak, mahogany, chestnut, birch tree, larch, hazelnut, lime tree, willow, poplar, elm, Scots pine, plane tree, obeche or aspen.

The wood substrate being veneered is not preferred, in particular the wood substrate being veneered, plywood or chipboard is not particularly preferred.

The coating layers may be applied as a composition to the wood substrates by the customary methods, for example by brushing, spraying, pouring, dipping or electrophoresis; see also Ullmann's Encyclopedia of Industrial Chemistry, 5th Edition, Vol. A18, pp. 491-500.

Depending on the binder system, the coatings may be cured at room temperature or by heating. The coatings may for example be cured at 50-150° C., and in the case of powder coatings even at higher temperatures.

The coatings compositions can comprise an organic solvent or solvent mixture in which the binder is soluble. The coatings compositions can otherwise be an aqueous solution or dispersion. The vehicle can also be a mixture of an organic solvent and water. The coating composition may be a high-solids paint or can be solvent-free (e.g. a powder coating material). Powder coatings are, for example, those described in Ullmann's Encyclopedia of Industrial Chemistry, 5th Ed., A18, pages 438-444. The powder coating material may also have the form of a powder-slurry (dispersion of the powder preferably in water).

The coating compositions described herein are for instance cured by physical drying (e.g. at room temperature or elevated temperature up to 100° C.) or by chemical curing. Examples of chemical curing are oxidative cross-linking (e.g. with alkyd or urethane alkyd resins), acid catalyzed curing (e.g. of amid, amino or phenol resins), radical curing (e.g. of aliphatic double bonds containing oligomers or monomers initiated by photoinitiators (such as UV or electron beam curing) or catalyzed for instance by organic peroxides) or polyaddition (e.g. of one- or two-component polyurethane or two-component epoxide resins).

For example, the coating layer (a) is not a cationically UV cured coating layer.

The tinted clear coating layer (b) being a powder coating layer is not preferred. For example, the tinted clear coating layer (b) is a waterborne or solventborne coating layer. For instance, all coating layers are waterborne or solventborne coating layers. For instance, the waterborne or solventborne coating layers describes herein are made of coating compositions comprising up to 85 wt % solvent or water based on the weight of the coating composition. Suitable solvents for solventborne coating compositions are esters (e.g. butylacetate, butylglycolacetate or methoxypropylacetate), glycolethers, ketones, cycloaliphatic or aromatic hydrocarbons.

For instance, the coating layer (b) and the coating layer (d) (if present) comprise a dye.

For example, the coating layer (b) and the coating layer (d) (if present) comprise a pigment.

Preferably, a coating layer, especially a tinted clear coating layer, is from 20 to 80 μm, more preferably from 20 to 70 μm, most preferably from 20 to 60 μm (dry film thickness).

Preferred is a tinted clear coating for wood, wherein the wood is untreated or treated with a stain or impregnation which penetrates into the wood pores of the surface of the wood.

A stain or impregnation is to be understood as a wood treatment or coloring of the wood surface which penetrates into the wood pores of the surface of the wood and does not form a film on the wood surface.

Preferred are stain or impregnation compositions that comprise no binder or a low amount of binder, i.e. 0-15 wt-%, especially 0-14 wt-%, based on the weight of the composition.

For instance, a stain comprises a pigment or dye as outlined herein as staining is coloring a wood surface with pigments or dyes including bleaching.

Preferably, the pigment concentration of the stain composition is from 0.002 to 20%, more preferably from 0.02 to 10%, most preferably from 0.1 to 5% by weight of solvent.

Preferably, the dye concentration of the stain composition is from 0.02 to 10%, more preferably from 0.05 to 5%, most preferably from 0.1 to 3% by weight of solvent.

For example, an impregnation comprises stabilizers (e.g. sterically hindered amine, UV absorber) as impregnating is treatment of wood with stabilizers.

Preferred is a tinted clear coating for wood, wherein the stain or impregnation comprises a sterically hindered amine, a UV absorber or combinations thereof, preferably the stain or impregnation comprises a sterically hindered amine. For instance, the sterically hindered amine is an N-oxyl or N-hydroxyl sterically hindered amine.

Preferred N-oxyl and N-hydroxyl sterically hindered amine are sterically hindered amines as described in WO-A-01/17738 from page 2, paragraph 4 to page 26, paragraph 2, especially 1-oxyl-2,2,6,6-tetramethyl-4-hydroxypiperidine, 1-hydroxy-2,2,6,6-tetramethyl-4-hydroxypiperidine, 1-hydroxy-2,2-6-6-tetramethyl-4-acetoxypiperidinium citrate, 1-hydroxy-2,2,6,6-tetramethyl-4-hydroxypiperidinium citrate, bis(1-hydroxy-2,2,6,6-tetramethyl-4-hydroxypiperidinium) citrate or tris(1-hydroxy-2,2,6,6-tetramethyl-4-hydroxypiperidinium) citrate.

In these stains and impregnations, the N-oxyl or N-hydroxyl sterically hindered amines can be used in an amount of 0.1-10%, preferably 0.2-5%, more preferably 0.2-2%, most preferably 0.5-1.5% by weight based on the weight of the solvent.

In these stains and impregnations, the UV absorbers can be used in an amount of 0.1-10%, preferably 0.2-5%, more preferably 0.2-2%, most preferably 0.5-1.5% by weight based on the weight of the solvent. The UV-absorbers can be as described below.

A stain and impregnation is usually applied as a liquid composition to the wood surface. This stain or impregnation composition may comprise a solvent, preferably selected from the group consisting of water without an organic solvent, an organic solvent without water and a mixture of water and an organic solvent. Suitable organic solvents are aliphatic, aromatic or cycloaliphatic hydrocarbons, alcohols, esters, ketones or chlorinated hydrocarbons. Water is preferred as a solvent.

The wood stain or impregnation can be applied to the wood using customary methods, for example by immersing the wood in a bath of the wood stain or impregnation, by paint-brushing, spraying or by knife-coating. The exposure time here can be up to several hours, and the temperature of the wood stain or impregnation bath can generally be between 20 and about 110° C.

When the treatment is complete, the wooden objects are generally dried in the air at room temperature. The treated wood can, however, also be dried at elevated temperatures up to about 100° C., e.g. in a convection drying cabinet.

Preferred is a tinted clear coating for wood, wherein the tinted clear coating layer (b) or the coating layer which is the outermost coating layer (i.e. the top coating layer) or both coating layers comprises a UV absorber.

The above paragraph is to be understood that the tinted clear coating layer (b) can be the outermost coating layer, i.e. top coating layer, which then can be the only coating layer comprising a UV absorber.

Preferably, the UV absorber concentration of the coating layer is from 0.2 to 10%, more preferably from 0.2 to 5%, even more preferably from 0.3 to 2%, most preferably from 0.5 to 1.5% by weight of solid binder.

For instance, in tinted clear coating for wood, the top coating layer comprises a sterically hindered amine and a UV absorber, especially a sterically hindered amine. Preferred sterically hindered amines are N—H, N-alkyl, N-acyl, N-alkoxy sterically hindered amines, whereby the alkoxy of N-alkoxy is unsubstituted or substituted by at least one hydroxy group.

Preferably, the sterically hindered amine concentration of the coating layer is from 0.2 to 10%, more preferably from 0.2 to 5%, even more preferably from 0.3 to 2%, most preferably from 0.5 to 1.5% by weight of solid binder.

Suitable sterically hindered amines are bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butanetetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)malonate, 3-n-octyl-7,7,9,9-tetramethyl-1,3,8-triazaspiro[4.5]decane-2,4-dione, bis(1-octyloxy-2,2,6,6-tetramethylpiperidyl)sebacate, bis(1-octyloxy-2,2,6,6-tetramethylpiperidyl)succinate, linear or cyclic condensates of N,N′-bis(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)ethane, the condensate of 2-chloro-4,6-di-(4-n-butylamino-1,2,2,6,6-pentamethylpiperidyl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensate of N,N′-bis(2,2,6,6-tetramethyl-4-piperidyl)hexamethylenediamine and 4-cyclohexylamino-2,6-dichloro-1,3,5-triazine, a condensate of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); a condensate of 1,6-hexanediamine and 2,4,6-trichloro-1,3,5-triazine as well as N,N-dibutylamine and 4-butylamino-2,2,6,6-tetramethylpiperidine (CAS Reg. No. [192268-64-7]); N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro-[4,5]decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexa-methylenediamine, a diester of 4-methoxymethylenemalonic acid with 1,2,2,6,6-pentamethyl-4-hydroxypiperidine, poly[methylpropyl-3-oxy-4-(2,2,6,6-tetramethyl-4-piperidyl)]siloxane, a reaction product of maleic acid anhydride-α-olefin copolymer with 2,2,6,6-tetramethyl-4-aminopiperidine or 1,2,2,6,6-pentamethyl-4-aminopiperidine, 2,4-bis[N-(1-cyclohexyloxy-2,2,6,6-tetramethylpiperidine-4-yl)-N-butylamino]-6-(2-hydroxyethyl)amino-1,3,5-triazine, 1-(2-hydr-oxy-2-methylpropoxy)-4-octadecanoyloxy-2,2,6,6-tetramethylpiperidine, 5-(2-ethylhexanoyl)-oxymethyl-3,3,5-trimethyl-2-morpholinone, Sanduvor (Clariant; CAS Reg. No. 106917-31-1], 5-(2-ethylhexanoyl)oxymethyl-3,3,5-trimethyl-2-morpholinone, the reaction product of 2,4-bis-[(1-cyclohexyloxy-2,2,6,6-piperidine-4-yl)butylamino]-6-chloro-s-triazine with N,N′-bis(3-aminopropyl)ethylenediamine), 1,3,5-tris(N-cyclohexyl-N-(2,2,6,6-tetramethylpiperazine-3-one-4-yl)amino)-s-triazine, 1,3,5-tris(N-cyclohexyl-N-(1,2,2,6,6-pentamethylpiperazine-3-one-4-yl)-amino)-s-triazine.

For instance, the tinted clear coating for wood comprises a UV absorber selected from the group consisting of 2-(2-hydroxyphenyl)-1,3,5-triazines, oxamides, acrylates, esters of substituted and unsubstituted benzoic acids, 2-hydroxybenzophenones, 2-(2′-hydroxyphenyl)benzotriazoles, transparent metal oxides and combinations thereof, preferably 2-(2-hydroxyphenyl)-1,3,5-triazines, 2-hydroxybenzophenones, 2-(2′-hydroxyphenyl)benzotriazoles and combinations thereof, most preferably 2-(2-hydroxyphenyl)-1,3,5-triazines.

Preferably, the coating layer comprises two UV absorbers, for instance a 2-(2-hydroxyphenyl)-1,3,5-triazine or a 2-(2′-hydroxyphenyl)benzotriazole with another UV absorber, especially in a ratio from 4:1 to 1:4 by weight.

Preferably, the transparent metal oxide is a titanium dioxide, a zinc oxide, a cerium oxide or an iron oxide. The primary particle size can vary from 1 to 100 nm, preferably from 5 to 50 nm, most preferably from 5 to 30 nm.

2-(2′-Hydroxyphenyl)benzotriazoles are, for example, 2-(2′-hydroxy-5′-methylphenyl)-benzo-triazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chloro-benzotriazole, 2-(3′-tert-butyl-2′-hydroxy-5′-methylphenyl)-5-chloro-benzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis-(α,α-dimethylbenzyl)-2′-hydroxyphenyl)benzotriazole, 2-(3′-tert-butyl-2′-hydroxy-5′-(2-octyloxycarbonylethyl)phenyl)-5-chloro-benzotriazole, 2-(3′-tert-butyl-5′-[2-(2-ethylhexyloxy)-carbonylethyl]-2′-hydroxyphenyl)-5-chloro-benzotriazole, 2-(3′-tert-butyl-2′-hydroxy-5′-(2-methoxycarbonylethyl)phenyl)-5-chloro-benzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonyl-ethyl)phenyl)benzotriazole, 2-(3′-tert-butyl-5′-[2-(2-ethylhexyloxy)carbonylethyl]-2′-hydroxy-phenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylene-bis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300; [R—CH₂CH₂—COO—CH₂CH₂₂, where R=3′-tert-butyl-4′-hydroxy-5′-2H-benzotriazol-2-ylphenyl, 2-[2′-hydroxy-3′-(α,α-dimethylbenzyl)-5′-(1,1,3,3-tetramethylbutyl)-phenyl]-benzotriazole; 2-[2′-hydroxy-3′-(1,1,3,3-tetramethylbutyl)-5′-(α,α-dimethylbenzyl)-phenyl]benzotriazole.

The 2-(2′-hydroxyphenyl)benzotriazoles can also be as described in GB-A-2319035 from page 2, penultimate paragraph to page 17, ultimate paragraph.

2-Hydroxybenzophenones are, for example, the 4-hydroxy, 4-methoxy, 4-octyloxy, 4-decyl-oxy, 4-dodecyloxy, 4-benzyloxy, 2-hydroxy-4-octyloxy, 4,2′,4′-trihydroxy and 2′-hydroxy-4,4′-dimethoxy derivatives.

Esters of substituted and unsubstituted benzoic acids are, for example, 4-tert-butyl-phenyl salicylate, phenyl salicylate, octylphenyl salicylate, dibenzoyl resorcinol, bis(4-tert-butylbenzoyl)resorcinol, benzoyl resorcinol, 2,4-di-tert-butylphenyl 3,5-di-tert-butyl-4-hydroxybenzo-ate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.

Acrylates are, for example, ethyl α-cyano-β,β-diphenylacrylate, isooctyl α-cyano-β,β-diphenylacrylate, methyl α-carbomethoxycinnamate, methyl α-cyano-β-methyl-p-methoxycinnamate, butyl α-cyano-β-methyl-p-methoxy-cinnamate, methyl α-carbomethoxy-p-methoxycinnamate, N-(β-carbomethoxy-β-cyanovinyl)-2-methylindoline, neopentyl tetra(α-cyano-β,β-di-phenylacrylate.

Oxamides are, for example, 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.

For instance, the 2-(2-hydroxyphenyl)-1,3,5-triazine UV absorber is a compound of formula (I), (II), (III), (IV), (V) or (VI), preferably of formula (I), (II) or (III)

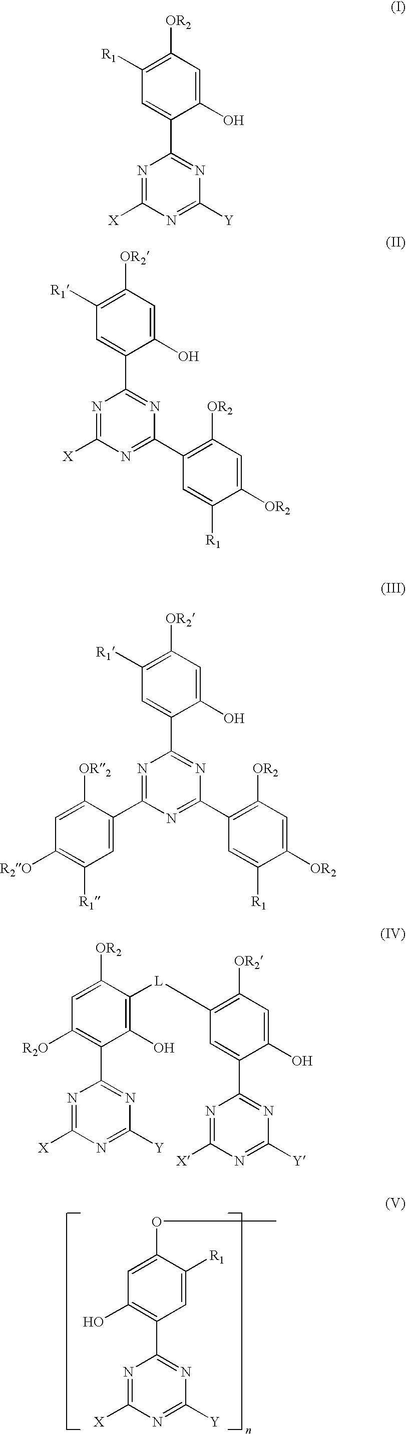

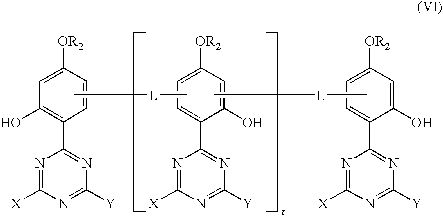

wherein
X and Y are independently phenyl, naphthyl, pyrenyl, phenanthrenyl or fluoranthenyl, or said phenyl, said naphthyl, said pyrenyl, said phenanthrenyl or said fluoranthenyl substituted by one to three alkyl of 1 to 6 carbon atoms, by halogen, by hydroxy or by alkoxy of 1 to 6 carbon atoms or by mixtures thereof; or are independently Z₁ or Z₂;
X, X′, Y and Y′ are the same or different and are as defined for X and Y;
R₁ is hydrogen, straight or branched chain alkyl of 1 to 24 carbon atoms, cycloalkyl of 5 to 12 carbon atoms, phenylalkyl of 7 to 15 carbon atoms, halogen, —SR₃, —SOR₃ or —SO₂R₃; or said alkyl, said cycloalkyl or said phenylalkyl substituted by one to three halogen, —R₄, —OR₅, —N(R₅)₂, —COR₅, —COOR₅, —OCOR₅, —CN, —NO₂, —SR₅, —SOR₅, —SO₂R₅ or —P(O)(OR₅)₂, morpholinyl, piperidinyl, 2,2,6,6-tetramethylpiperidinyl, piperazinyl or N-methylpiperidinyl groups or combinations thereof; or said alkyl or said cycloalkyl interrupted by one to four phenylene, —O—, —NR₅—, —CONR₅—, —COO—, —OCO— or —CO— groups or combinations thereof; or
said alkyl or said cycloalkyl both substituted and interrupted by combinations of the groups mentioned above;
R₁, R₁′ and R₁″ are the same or different and are as defined for R₁;
R₂ is hydrogen, straight or branched chain alkyl of 1 to 24 carbon atoms or cycloalkyl of 5 to 12 carbon atoms; or said alkyl or said cycloalkyl substituted by one to four halogen, epoxy, glycidyloxy, furyloxy, —R₄, —OR₅, —N(R₅)₂, —CON(R₅)₂, —COR₅, —COOR₅, —OCOR₅, —OCOC(R₅)═C(R₅)₂, —C(R₅)═CCOOR₅, —CN, —NCO, or

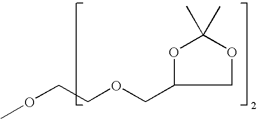

or combinations thereof; or said alkyl or said cycloalkyl interrupted by one to four epoxy, —O—, —NR₅—, —CONR₅—, —COO—, —OCO—, —CO—, —C(R₅)═C(R₅)COO—, —OCOC(R₅)═C(R₅)—, —C(R₅)═C(R₅)—, phenylene or phenylene-G-phenylene in which G is —O—, —S—, —SO₂—, —CH₂— or —C(CH₃)₂— or combinations thereof, or said alkyl or said cycloalkyl both substituted and interrupted by combinations of the groups mentioned above; or R₂ is —SO₂R₃ or —COR₆;
R₂, R₂′ and R₂″ are the same or different and are as defined for R₂;
R₃ is alkyl of 1 to 20 carbon atoms, alkenyl of 3 to 18 carbon atoms, cycloalkyl of 5 to 12 carbon atoms, phenylalkyl of 7 to 15 carbon atoms, aryl of 6 to 10 carbon atoms or said aryl substituted by one or two alkyl of 1 to 4 carbon atoms;
R₄ is aryl of 6 to 10 carbon atoms or said aryl substituted by one to three halogen, alkyl of 1 to 8 carbon atoms, alkoxy of 1 to 8 carbon atoms or combinations thereof; cycloalkyl of 5 to 12 carbon atoms; phenylalkyl of 7 to 15 carbon atoms or said phenylalkyl substituted on the phenyl ring by one to three halogen, alkyl of 1 to 8 carbon atoms, alkoxy of 1 to 8 carbon atoms or combinations thereof; or straight or branched chain alkenyl of 2 to 18 carbon atoms;
R₅ is defined as is R₄; or R₅ is also hydrogen or straight or branched chain alkyl of 1 to 24 carbon atoms, alkenyl of 2 to 24 carbon atoms; or R₅ is a group for formula

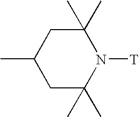

T is hydrogen, oxyl, hydroxyl, —OT₁, alkyl of 1 to 24 carbon atoms, said alkyl substituted by one to three hydroxy; benzyl or alkanoyl of 2 to 18 carbon atoms;
T₁ is alkyl of 1 to 24 carbon atoms, cycloalkyl of 5 to 12 carbon atoms, alkenyl of 2 to 24 carbon atoms, cycloalkenyl of 5 to 12 carbon atoms, phenylalkyl of 7 to 15 carbon atoms, a radical of a saturated or unsaturated bicyclic or tricyclic hydrocarbon of 7 to 12 carbon atoms or aryl of 6 to 10 carbon atoms or said aryl substituted by one to three alkyl of 1 to 4 carbon atoms;
R₆ is straight or branched chain alkyl of 1 to 18 carbon atoms, straight or branched chain alkenyl of 2 to 12 carbon atoms, phenoxy, alkylamino of 1 to 12 carbon atoms, arylamino of 6 to 12 carbon atoms, —R₇COOH or —NH—R₈—NCO;
R₇ is alkylene of 2 to 14 carbon atoms or phenylene;
R₈ is alkylene of 2 to 24 carbon atoms, phenylene, tolylene, diphenylmethane or a group

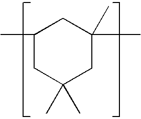

t is 0 to 9;
L is straight or branched alkylene of 1 to 12 carbon atoms, cycloalkylene of 5 to 12 carbon atoms or alkylene substituted or interrupted by cyclohexylene or phenylene; or L is benzylidene; or L is —S—, —S—S—, —S-E-S—, —SO—, —SO₂—, —SO-E-SO—, —SO₂-E-SO₂—, —CH₂—NH-E-NH—CH₂— or

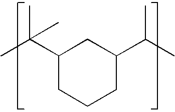

E is alkylene of 2 to 12 carbon atoms, cycloalkylene of 5 to 12 carbon atoms or alkylene interrupted or terminated by cycloalkylene of 5 to 12 carbon atoms;
n is 2, 3 or 4;
when n is 2; Q is straight or branched alkylene of 2 to 16 carbon atoms; or said alkylene substituted by one to three hydroxy groups; or said alkylene interrupted by one to three —CH═CH— or —O—; or said alkylene both substituted and interrupted by combinations of the groups mentioned above; or Q is xylylene or a group —CONH—R₈—NHCO—, —CH₂CH(OH)CH₂O —R₉—OCH₂CH(OH)CH₂—, —CO—R₁₀—CO—, or —(CH₂)ₘ—COO—R₁₁—OOC—(CH₂)ₘ—, where m is 1 to 3;

### or Q is

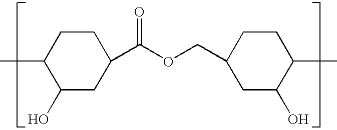

R₉ is alkylene of 2 to 50 carbon atoms; or said alkylene interrupted by one to ten —O—, phenylene or a group -phenylene-G-phenylene in which G is —O—, —S—, —SO₂—, —CH₂— or —C(CH₃)₂—;
R₁₀ is alkylene of 2 to 10 carbon atoms, or said alkylene interrupted by one to four —O—, —S— or —CH═CH—; or R₁₀ is arylene of 6 to 12 carbon atoms;
R₁₁ is alkylene of 2 to 20 carbon atoms or said alkylene interrupted by one to eight —O—; when n is 3, Q is a group —[(CH₂)ₘCOO]₃—R₁₂ where m is 1 to 3, and R₁₂ is an alkanetriyl of 3 to 12 carbon atoms;
when n is 4, Q is a group —[(CH₂)ₘCOO]₄—R₁₃ where m is 1 to 3, and R₁₃ is an alkanetetrayl of 4 to 12 carbon atoms;
Z₁ is a group of formula

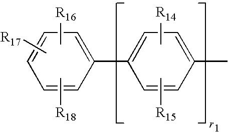

Z₂ is a group of formula

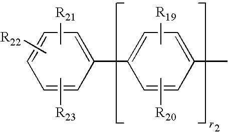

where
r₁ and r₂ are independently of each other 0 or 1;
R₁₄, R₁₅, R₁₆, R₁₇, R₁₈, R₁₉, R₂₀, R₂₁, R₂₂ and R₂₃ are independently of one another hydrogen, hydroxy, cyano, alkyl of 1 to 20 carbon atoms, alkoxy of 1 to 20 carbon atoms, phenylalkyl of 7 to 15 carbon atoms, cycloalkyl of 5 to 12 carbon atoms, cycloalkoxy of 5 to 12 carbon atoms, halogen, haloalkyl of 1 to 5 carbon atoms, sulfo, carboxy, acylamino of 2 to 12 carbon atoms, acyloxy of 2 to 12 carbon atoms, alkoxycarbonyl of 2 to 12 carbon atoms or aminocarbonyl; or R₁₇ and R₁₈ or R₂₂ and R₂₃ together with the phenyl radical to which they are attached are a cyclic radical interrupted by one to three —O— or —NR₅—

For instance, alkyl or alkylene comprises at least 2 carbon atoms if said alkyl or said alkylene is interrupted by one or more groups (e.g. phenylene, —O—, —NR₅—, —CONR₅—, —COO—, —OCO—, —CO—, epoxy, —C(R₅)═C(R₅)COO—, —OCOC(R₅)═C(R₅)—, —C(R₅)═C(R₅)— or phenylene-G-phenylene groups).

When a denotation (e.g. R₂′ or R₂″) occurs more than once (e.g. twice) in a compound, this denotation may be different groups or the same group.

In the definitions the term alkyl comprises within the given limits of carbon atoms, for example methyl, ethyl, propyl, isopropyl, n-butyl, sec-butyl, isobutyl, tert-butyl, 2-ethylbutyl, n-pentyl, isopentyl, 1-methylpentyl, 1,3-dimethylbutyl, n-hexyl, 1-methylhexyl, n-heptyl, 2-methylheptyl, 1,1,3,3-tetramethylbutyl, 1-methylheptyl, 3-methylheptyl, n-octyl, 2-ethylhexyl, 1,1,3-trimethylhexyl, 1,1,3,3-tetramethylpentyl, nonyl, decyl, undecyl, 1-methylundecyl or dodecyl.

Examples of alkenyl are within the given limits of carbon atoms vinyl, allyl, 1-methylethenyl, and the branched and unbranched isomers of butenyl, pentenyl, hexenyl, heptenyl, octenyl, nonenyl, decenyl, undecenyl and dodecenyl. The term alkenyl also comprises residues with more than one double bond that may be conjugated or non-conjugated, for example may comprise one double bond.

Examples of alkylene are within the given limits of carbon atoms branched and unbranched isomers of ethylene, propylene, butylene, pentylene, hexylene, heptylene, octylene, nonylene, decylene, undecylene and dodecylene.

Some examples of cycloalkyl are cyclopentyl, cyclohexyl, methylcyclopentyl, dimethylcyclopentyl and methylcyclohexyl.

Some examples of cycloalkylene are cyclopentylene, cyclohexylene (e.g. 1,4-cyclohexylene), methylcyclopentylene, dimethylcyclopentylene and methylcyclohexylene.

Some examples of cycloalkenyl are cyclopentenyl, cyclohexenyl, methylcyclopentenyl, dimethylcyclopentenyl and methylcyclohexenyl. Cycloalkenyl may comprise more than one double bond that may be conjugated or non-conjugated, for example may comprise one double bond.

Aryl is for example phenyl.

Arylene is for instance phenylene, especially o-, m- or p-phenylene.

Examples of phenylene are o-, m- and p-phenylene.

Phenylalkyl is for instance benzyl or α,α-dimethylbenzyl.

The term alkoxy may comprise within the limits of the given number of carbon atoms, for example methoxy and ethoxy and the branched and unbranched isomers of propoxy, butoxy, pentyloxy, hexyloxy, heptyloxy and octyloxy.

In the definitions the term alkanoyl comprises within the given limits of carbon atoms, for example ethanoyl, propanoyl and branched and unbranched isomers of butanoyl, pentanoyl, hexanoyl, heptanoyl, octanoyl, nonanoyl, decanoyl, undecanoyl and dodecanoyl.

The term halogen may comprise chlorine, bromine and iodine; for example halogen is chlorine.

For example, a radical of a saturated or unsaturated bicyclic or tricyclic hydrocarbon of 7 to 12 carbon atoms is decaline.

Preferably, the 2-(2-hydroxyphenyl)-1,3,5-triazine UV absorber is a compound of formula (I), (II) or (III), wherein

X and Y are independently phenyl, or said phenyl, substituted by one to three alkyl of 1 to 6 carbon atoms, by hydroxy or by alkoxy of 1 to 6 carbon atoms or by mixtures thereof; or are independently Z₁ or Z₂;
R₁ is hydrogen;
R₁′ and R₁″ are as defined for R₁;
R₂ is hydrogen, straight or branched chain alkyl of 1 to 24 carbon atoms; or said alkyl substituted by one to four —R₄, —OR₅, —N(R₅)₂, —CON(R₅)₂, —COR₅, —COOR₅, —OCOR₅, —OCOC(R₅)═C(R₅)₂, —C(R₅)═CCOOR₅, or combinations thereof; or said alkyl interrupted by one to four —O—, —NR₅—, —CONR₅—, —COO—, —OCO—, —CO—, —C(R₅)═C(R₅)COO—, —OCOC(R₅)═C(R₅)—, —C(R₅)═C(R₅)—, or combinations thereof, or said alkyl both substituted and interrupted by combinations of the groups mentioned above; or R₂ is —COR₆;
R₂, R₂′ and R₂″ are the same or different and are as defined for R₂;
R₄ is straight or branched chain alkenyl of 2 to 18 carbon atoms;
R₅ is defined as is R₄; or R₅ is also hydrogen or straight or branched chain alkyl of 1 to 24 carbon atoms, alkenyl of 2 to 24 carbon atoms;
R₆ is straight or branched chain alkyl of 1 to 18 carbon atoms, straight or branched chain alkenyl of 2 to 12 carbon atoms, alkylamino of 1 to 12 carbon atoms;
Z₁ is a group of formula

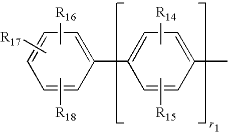

Z₂ is a group of formula

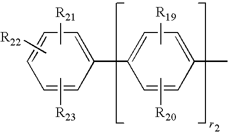

where
r₁ and r₂ are independently of each other 0 or 1;
R₁₄, R₁₅, R₁₆, R₁₇, R₁₈, R₁₉, R₂₀, R₂₁, R₂₂ and R₂₃ are independently of one another hydrogen, hydroxy, alkyl of 1 to 20 carbon atoms, alkoxy of 1 to 20 carbon atoms, carboxy, acylamino of 2 to 12 carbon atoms, acyloxy of 2 to 12 carbon atoms, alkoxycarbonyl of 2 to 12 carbon atoms or aminocarbonyl.

More preferably, the 2-(2-hydroxyphenyl)-1,3,5-triazine UV absorber is compound of formula (I), (II) or (III), especially of formula (I) or (III), wherein

X and Y are independently phenyl, or said phenyl, substituted by one to two alkyl of 1 carbon atom, by hydroxy or by alkoxy of 1 to 6 carbon atoms or by mixtures thereof; or are independently Z₁ or Z₂;

R₁ is hydrogen;
R₁′ and R₁″ are as defined for R₁;
R₂ is hydrogen, straight or branched chain alkyl of 1 to 15 carbon atoms; or said alkyl substituted by one or two —R₄, —OR₅, —COOR₅, —OCOR₅, —OCOC(R₅)═C(R₅)₂, —C(R₅)═CCOOR₅, or combinations thereof; or said alkyl interrupted by one or two —O—, —COO—, —OCO— or combinations thereof, or said alkyl both substituted and interrupted by combinations of the groups mentioned above; or R₂ is —COR_{E};
R₂, R₂′ and R₂″ are the same or different and are as defined for R₂;
R₄ is straight or branched chain alkenyl of 2 to 3 carbon atoms;
R₅ is defined as is R₄; or R₅ is also hydrogen or straight or branched chain alkyl of 1 to 15 carbon atoms, alkenyl of 2 to 3 carbon atoms;
R₆ is straight or branched chain alkyl of 1 to 15 carbon atoms, straight or branched chain alkenyl of 2 to 3 carbon atoms;
Z₁ is a group of formula

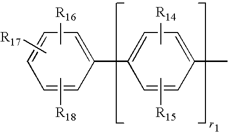

Z₂ is a group of formula

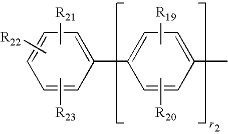

where
r₁ and r₂ are 1;
R₁₄, R₁₅, R₁₆, R₁₇, R₁₈, R₁₉, R₂₀, R₂₁, R₂₂ and R₂₃ are hydrogen.

Even more preferably, the 2-(2-hydroxyphenyl)-1,3,5-triazine UV absorber is a compound of formula (I), (II) or (III), especially of formula (I) or (III), in particular of formula (III), wherein X and Y are independently phenyl, or said phenyl, substituted by one to two alkyl of 1 carbon atom, by hydroxy or by alkoxy of 1 to 6 carbon atoms or by mixtures thereof; or are independently Z₁ or Z₂;

R₁, R₁′ and R₁″ are hydrogen;
R₂ is hydrogen, straight or branched chain alkyl of 1 to 15 carbon atoms; or said alkyl substituted by one or two —OR₅, —COOR₅, —OCOR₅, —OCOC(R₅)═C(R₅)₂, or combinations thereof; or said alkyl interrupted by one —O—, —COO— or —OCO—, or said alkyl both substituted and interrupted by combinations of the groups mentioned above; or R₂ is —COR₆;
R₂, R₂′ and R₂″ are the same or different and are as defined for R₂;
R₅ is hydrogen or straight or branched chain alkyl of 1 to 15 carbon atoms, alkenyl of 2 to 3 carbon atoms;
R₆ is straight or branched chain alkenyl of 2 to 3 carbon atoms;
Z₁ is a group of formula

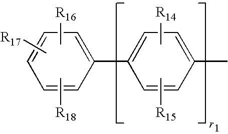

Z₂ is a group of formula

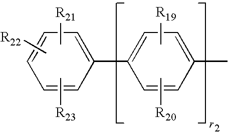

where
r₁ and r₂ are 1;
R₁₄, R₁₅, R₁₆, R₁₇, R₁₈, R₁₉, R₂₀, R₂₁, R₂₂ and R₂₃ are hydrogen.

For instance, the 2-(2-hydroxyphenyl)-1,3,5-triazine UV absorber (a) is of formula (III), wherein

R₁, R₁′ and R₁″ are hydrogen;
R₂ is hydrogen, straight or branched chain alkyl of 1 to 15 carbon atoms; or said alkyl substituted by one —OR₅, —COOR₅, —OCOR₅, or said alkyl interrupted by one —O—, —COO— or —OCO—;
R₂, R₂′ and R₂″ are the same or different and are as defined for R₂;
R₅ is hydrogen or straight or branched chain alkyl of 1 to 15 carbon atoms, alkenyl of 2 to 3 carbon atoms; and
R₆ is straight or branched chain alkenyl of 2 to 3 carbon atoms.

For example, the 2-(2-hydroxyphenyl)-1,3,5-triazine UV absorber (a) is of formula (III), wherein

R₁, R₁′ and R₁″ are hydrogen;
R₂ is hydrogen or straight or branched chain alkyl of 1 to 8 carbon atoms substituted by one —COOR₅;
R₂, R₂′ and R₂″ are the same or different and are as defined for R₂;
R₅ is straight or branched chain alkyl of 1 to 12 carbon atoms.

Examples of suitable 2-(2-hydroxyphenyl)-1,3,5-triazine UV absorbers are:

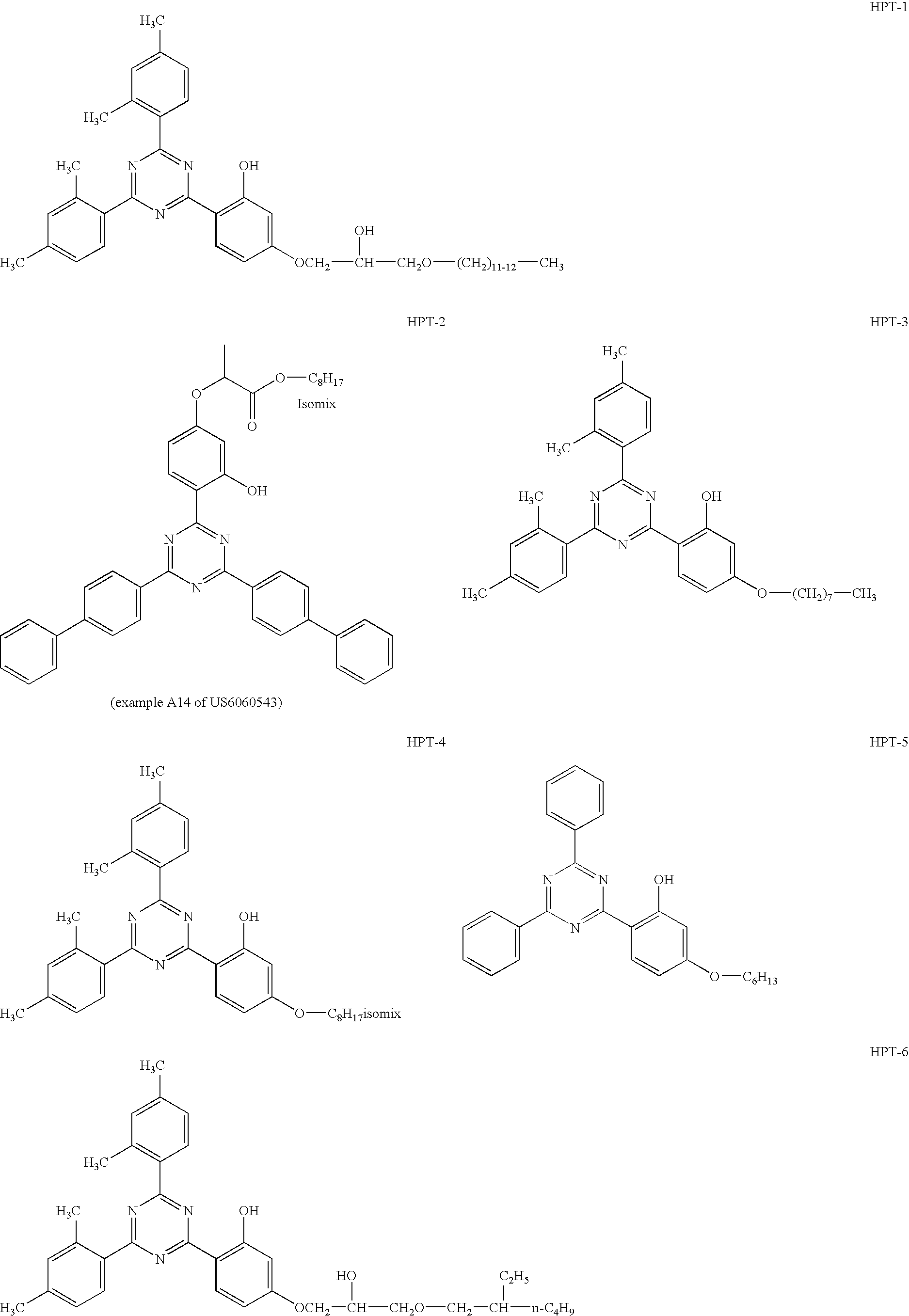

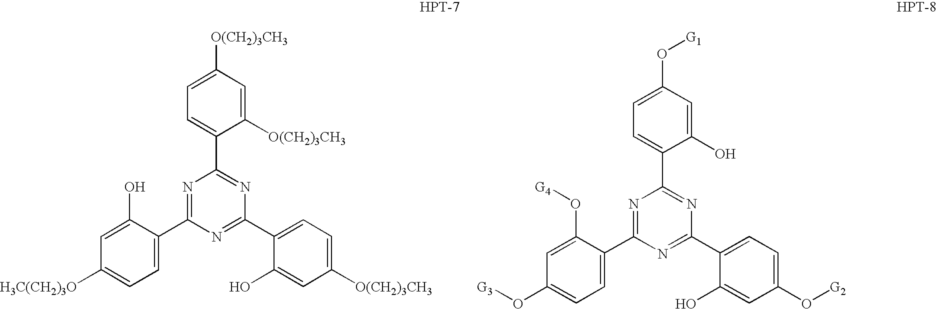

HPT-8 is a mixture of compounds with substituents as defined in 1), 2) and 3)

1) G₁=G₂=CH(CH₃)—COO—C₈H₁₇ isomix, G₃=G₄=H;
2) G₁=G₂=G₃=CH(CH₃)—COO—C₈H₁₇ isomix, G₄=H;
3) G₁=G₂=G₃=G₄=CH(CH₃)—COO—C₈H₁₇ isomix;

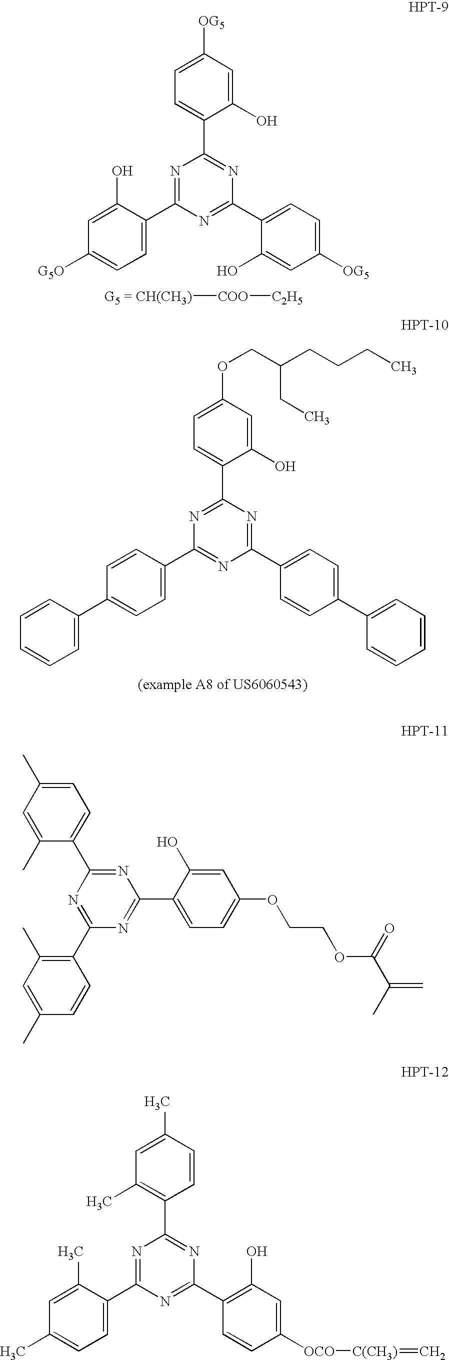

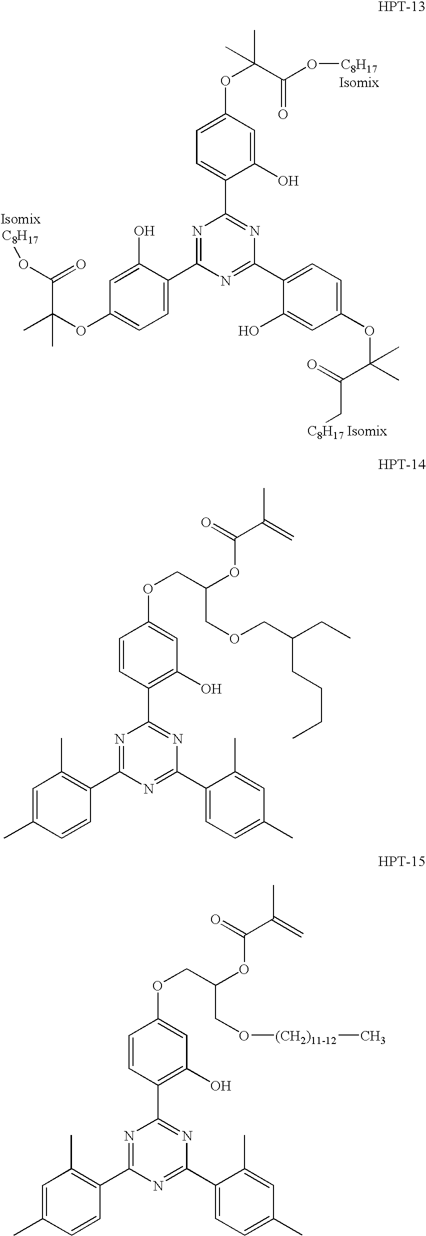

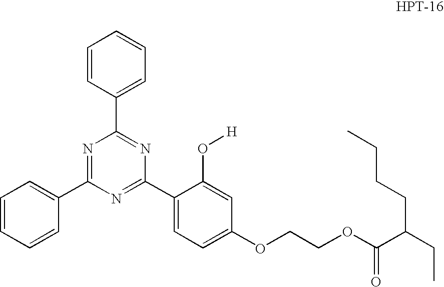

HPT-17 2,4,6-tris(2-hydroxy-4-octyloxyphenyl)-1,3,5-triazine,
HPT-18 2-(2,4-dihydroxyphenyl)-4,6-bis(2,4-dimethylphenyl)-1,3,5-triazine,
HPT-19 2,4-bis(2-hydroxy-4-propyl-oxyphenyl)-6-(2,4-dimethylphenyl)-1,3,5-triazine,
HPT-20 2-(2-hydroxy-4-octyloxyphenyl)-4,6-bis(4-methylphenyl)-1,3,5-triazine,
HPT-21 2-(2-hydroxy-4-dodecyloxyphenyl)-4,6-bis(2,4-dimethylphenyl)-1,3,5-triazine,
HPT-22 2-(2-hydroxy-4-tridecyloxyphenyl)-4,6-bis(2,4-dimethylphenyl)-1,3,5-triazine,

HPT-23 2-[2-hydroxy-4-(2-hydroxy-3-butyloxypropoxy)phenyl]-4,6-bis(2,4-dimethyl)-1,3,5-triazine,
HPT-24 2-[2-hydroxy-4-(2-hydroxy-3-octyloxypropyloxy)phenyl]-4,6-bis(2,4-dimethyl)-1,3,5-triazine,
HPT-25 2-[2-hydroxy-4-(2-hydroxy-3-dodecyloxypropoxy)phenyl]-4,6-bis(2,4-dimethylphenyl)-1,3,5-triazine,
HPT-26 2-(2-hydroxy-4-hexyloxy)phenyl-4,6-diphenyl-1,3,5-triazine,
HPT-27 2-(2-hydroxy-4-methoxyphenyl)-4,6-diphenyl-1,3,5-triazine,
HPT-28 2,4,6-tris[2-hydroxy-4-(3-butoxy-2-hydroxy-propoxy)phenyl]-1,3,5-triazine,
HPT-29 2-(2-hydroxyphenyl)-4-(4-methoxyphenyl)-6-phenyl-1,3,5-triazine,
HPT-30 2,4-bis(4-[2-ethylhexyloxy]-2-hydroxyphenyl)-6-(4-methoxyphenyl)-1,3,5-triazine.

Most preferred 2-(2-hydroxyphenyl)-1,3,5-triazine UV absorbers are HPT-1 to HPT-8, in particular HPT-8.

Mixture of two or more different 2-(2-hydroxyphenyl)-1,3,5-triazine UV absorbers can be used. For instance, a mixture of two different 2-(2-hydroxyphenyl)-1,3,5-triazine UV absorbers. Preferred mixtures are HPT-1 and HPT-2; HPT-2 and HPT-6; HPT-2 and HPT3; HPT-2 and HPT-4; HPT-2 and HPT-5; HPT-1 and HPT-7; HPT-1 and HPT-7; HPT-3 and HPT-7; HPT-4 and HPT-7; HPT-5 and HPT-7; HPT-6 and HPT-7; HPT-1 and HPT-8; HPT-3 and HPT-8; HPT-4 and HPT-8; HPT-5 and HPT-8; HPT-6 and HPT-8. The ratio of the two different 2-(2-hydroxyphenyl)-1,3,5-triazine UV absorbers in the mixture is, for instance, 4:1 to 1:4, preferably 3:1 to 1:3, even more preferred 2.5:1 to 1:2.5 by weight.

The organic UV absorbers (e.g. 2-(2-hydroxyphenyl)-1,3,5-triazines, oxamides, acrylates, esters of substituted and unsubstituted benzoic acids, 2-hydroxybenzophenones, 2-(2′-hydroxyphenyl)benzotriazoles) can be used per se or can be used as a concentrated aqueous polymer dispersion comprising the organic UV absorber. Such concentrated aqueous polymer dispersions comprising an organic UV absorber can be for example as described in WO-A-05/023878 and can be obtained as described in WO-A-05/023878. The preferences for these concentrated aqueous polymer dispersions comprising an organic UV absorber can be the same as described herein for the product per se. Such concentrated aqueous polymer dispersions comprising an organic UV absorber are especially suitable for water-based coatings.

The above UV absorbers are mainly commercially available. For instance, 2-(2-hydroxyphenyl)-1,3,5-triazine UV absorbers and their starting materials can be prepared by methods known in the art. For example, the 2-(2-hydroxyphenyl)-1,3,5-triazine UV absorbers are prepared by Friedel-Crafts addition of halotriazines to corresponding aromatic compounds and phenols analogously to one of the methods specified in EP-A-434 608 or in one of the publications mentioned at the beginning thereof or analogously to one of the methods specified in the publication by H. Brunetti and C. E. Lüthi, Helv. Chim. Acta 55, 1566 (1972); see also U.S. Pat. Nos. 5,726,310, 6,057,444, 6,225,468, and EP-A-941 989, WO 00/29392. That procedure can be followed by a further reaction according to known methods; such reactions and processes are described, for example, in EP-A-434 608. Hydroxyphenyl triazine UV absorber are described e.g. in GB-A-975966, EP-A-434608, U.S. Pat. No. 4,619,956, U.S. Pat. No. 5,298,067, EP-A-530135, EP-A-520938, EP-A-531258, U.S. Pat. No. 5,556,973, U.S. Pat. No. 5,959,008, U.S. Pat. No. 6,184,375, U.S. Pat. No. 6,117,997; for example in U.S. Pat. No. 5,998,116, U.S. Pat. No. 6,255,483, U.S. Pat. No. 6,060,543.

The UV absorbers in the stain, impregnation, tinted clear coating layer or top coating layer can be as outlined above.

For example, the tinted clear coating for wood comprises a dye selected from the group consisting of solvent dyes, disperse dyes, acid dyes, reactive dyes, basic dyes, metal complex dyes and combinations thereof,

preferably solvent dyes and acid dyes and combinations thereof. Combinations should be understood to be at least two different dyes selected from the same or different dye classes, preferably from the same dye class.

The dyes can also be as described in WO-A-01/85857 from page 33, paragraph 3 to page 51, paragraph 3. Other examples of dyes are C.I. Acid Yellow 220 and C.I. Acid Black 52.

Preferably, the dye concentration of the tinted clear coating is from 0.02 to 5%, more preferably from 0.1 to 1%, most preferably from 0.2 to 0.8% by weight of solid binder.

For instance, the pigment may be of any colour including black and white. Generally, the pigment is a pigment or a mixture of pigments selected from the group consisting of organic pigments and inorganic pigments.

The organic pigments may be those producing the colours commonly used in the pigment-using industries, such as the coating industry: namely black, blue, red, green, orange and yellow.

Organic pigments comprise for example, polycylic, azo and metal complex pigments. More particularly organic pigments comprise for instance monoazo, disazo, β-naphthol, naphthol AS, laked azo, benzimidazolone, azocondensation, metal-complex azo, azomethine, isoindolinone, isoindoline, metal complexes such as phthalocyanine, quinacridone, perylene, perinone, indigo, thioindigo, anthraquinone, indanthrone, anthrapyrimidine, flavanthrone, pyranthrone, anthanthrone, dioxazine, triarylcarbonium, quinophthalone, diketopyrrolopyrrole, nitro, quinoline, isoviolanthrone, pteridine and basic dye complex pigments. The pigment may be a solid solution pigment. Mixtures of the pigments may also be used. Mixtures of crystal combinations of pigments may be used. Preferred pigments are selected from the group consisting of benzimidazolone, isoindolinone, isoindoline, metal complexes such as phthalocyanine, quinacridone, perylene, anthraquinone, indanthrone and diketopyrrolopyrrole. For further details as to all those organic pigments, reference is made to Industrial Organic Pigments, W. Herbst, K. Hunger, 2^{nd} edition, VCH Verlagsgesellschaft, Weinheim, 1997.

The inorganic pigments include among others titanium oxide pigments, iron oxide and hydroxide pigments, chromium oxide pigments, spinel type calcined pigments, lead chromate pigments, carbon black and Prussian Blue.

The pigments described herein except the flake pigments, organic platelets and interference pigments are, for instance, 5-2000 nm, preferably 10-1000 nm in size. The flake pigments, organic platelets and interference pigments have, for example, an average particle size of 5-150 μm and a thickness of 0.1-2 μm.

Flake pigments, especially interference flake pigments, for instance metal flake pigments are preferred.

Particularly suitable pigments are those listed in the Colour Index (CI) edited by the Society of Dyers and Colourists and the American Association of Textile Chemists and Colorists.

Such pigments are mainly commercially available. Otherwise such pigments can be prepared according to methods known in the art.

For instance, the pigment is selected from the group consisting of a C.I. Pigment Red 23, 101, 112, 144, 146, 166, 177, 179, 184, 185, 202, 206, 221, 254, 255, 264, a C.I. Pigment Violet 19, 23, 37, a C.I. Pigment Blue 15, 15:1, 15:2, 15:3, 15:4, 15:6, 16, 60, a C.I. Pigment Yellow 13, 17, 34, 42, 74, 83, 93, 109, 110, 128, 129, 139, 184, a C.I. Pigment Green 7, 36, a C.I. Pigment Orange 48, 73, a diketo-pyrrolo-pyrrol pigment, a quinacridone pigment; as well as mixtures, crystal combinations and solid solutions thereof,

most preferably a C.I. Pigment Red 101, 177, 179, 202, 254, 264, a C.I. Pigment Violet 19, 23, 37, a C.I. Pigment Blue 15, 15:1, 15:2, 15:3, 15:4, 15:6, 16, 60, a C.I. Pigment Yellow 42, 109, 110, 129, 184, a C.I. Pigment Green 7, 36, a C.I. Pigment Orange 48, 73, a diketo-pyrrolo-pyrrol pigment, a quinacridone pigment; as well as mixtures or solid solutions thereof, especially a C.I. Pigment Red 101, 177, 179, 202, 254, 264, a C.I. Pigment Violet 19, 23, 37, a C.I. Pigment Blue 15, 15:1, 15:2, 15:3, 15:4, 15:6, 16, 60, a C.I. Pigment Yellow 42, 109, 110, 129, 184, a C.I. Pigment Green 7, 36, a C.I. Pigment Orange 48, 73 or a mixture thereof.

These pigment mixtures and solid solutions of pigments are to be understood to include mixtures such as crystal mixtures and solid solutions of two or more diketo-pyrrolo-pyrrole pigments, of two or more quinacridone pigments and of two and more quinacridone/diketo-pyrrolo-pyrrole pigments.

Other preferred pigments are interference flake pigments (e.g. mica coated with transparent metal oxides like TiO₂ or Fe₂O₃) or organic platelets (i.e. pigments with colour flop like 2,9-dichloroquinacridone in platelet form).

Other preferred pigments are interference pigments, i.e. pigments based on transparent platelet-like substrates which are coated with metal oxides.

Suitable platelet-shaped substrates are transparent. Examples thereof are mica (biotite, vermiculite, sericite, muscovite, phlogopite, fluorophlogopite, kaolinite or related), or any synthetic mica, such as synthetic fluorophlogopite, basic lead carbonate, flaky barium sulfate, SiO₂, Al₂O₃, TiO₂, glass, ZnO, ZrO₂, SnO₂ and BiOCl flakes.

The transparent platelet-like substrate has preferably a low index of refraction. Particularly preferred substrates are natural, or synthetic mica, SiO₂ flakes, Al₂O₃ flakes, and glass flakes.

Preferred interference pigments comprise besides the transparent platelet-like substrate having a low index of refraction (a) a metal oxide of high refractive index, or a mixture of metal oxides of high refractive index.

Examples of suitable metal oxides of high refractive index are TiO₂, ZrO₂, Fe₂O₃, Fe₃O₄, Cr₂O₃ or ZnO, with TiO₂ being especially preferred.

Pigments on the basis of platelet-like metal oxides of low refractive index, which have been coated by a wet chemical method, in the indicated order are particularly preferred: TiO₂, (SnO₂)TiO₂ (substrate: metal oxide of low refractive index; layer: (SnO₂)TiO₂, preferably in the rutile modification), Fe₂O₃, Fe₃O₄, TiFe₂O₅, Cr₂O₃, ZrO₂, Sn(Sb)O₂, BiOCl, Al₂O₃, Fe₂O₃.TiO₂ (substrate: metal oxide of low refractive index; mixed layer of Fe₂O₃ and TiO₂), TiO₂/Fe₂O₃ (substrate: metal oxide of low refractive index; first layer: TiO₂; second layer: Fe₂O₃), TiO₂/Berlin blau, TiO₂/Cr₂O₃, or TiO₂/FeTiO₃. In general the thickness of layer a) ranges from 1 to 1000 nm, preferably from 1 to 300 nm.

In another particularly preferred embodiment the interference pigments contain at least three alternating layers of high and low refractive index, such as, for example, TiO₂/SiO₂/TiO₂, (SnO₂)TiO₂/SiO₂/TiO₂, TiO₂/SiO₂/TiO₂/SiO₂/TiO₂ or TiO₂/SiO₂/Fe₂O₃.

Preferably the layer structure is as follows:

(A) a coating having a refractive index >1.65,
(B) a coating having a refractive index ≦1.65,
(C) a coating having a refractive index >1.65, and
(D) optionally an outer protective layer.

The thickness of layer (A) is 10 to 550 nm, preferably 15 to 400 nm and, in particular, 20 to 350 nm. The thickness of layer (B) is 10 to 1000 nm, preferably 20 to 800 nm and, in particular, 30 to 600 nm. The thickness of layer (C) is 10 to 550 nm, preferably 15 to 400 nm and, in particular, 20 to 350 nm.

Particularly suitable materials for layer (A) are metal oxides, or metal oxide mixtures, such as TiO₂, Fe₂O₃, TiFe₂O₅, Fe₃O₄, BiOCl, CoO, CO₃O₄, Cr₂O₃, VO₂, V₂O₃, Sn(Sb)O₂, SnO₂, ZrO₂, iron titanates, iron oxide hydrates, titanium suboxides (reduced titanium species having oxidation states from 2 to <4), bismuth vanadate, cobalt aluminate, and also mixtures or mixed phases of these compounds with one another or with other metal oxides.

Particularly suitable materials for layer (B) are metal oxides or the corresponding oxide hydrates, such as SiO₂, MgF₂, Al₂O₃, AlOOH, B₂O₃ or a mixture thereof, preferably SiO₂.

Particularly suitable materials for layer (C) are colorless or colored metal oxides, such as TiO₂, Fe₂O₃, TiFe₂O₅, Fe₃O₄, BiOCl, CoO, CO₃O₄, Cr₂O₃, VO₂, V₂O₃, Sn(Sb)O₂, SnO₂, ZrO₂, iron titanates, iron oxide hydrates, titanium suboxides (reduced titanium species having oxidation states from 2 to <4), bismuth vanadate, cobalt aluminate, and also mixtures or mixed phases of these compounds with one another or with other metal oxides.

Interlayers of absorbing or nonabsorbing materials can be present between layers (A), (B), (C) and (D). The thickness of the interlayers is 1 to 50 nm, preferably 1 to 40 nm and, in particular, 1 to 30 nm. Such an interlayer can, for example, consist of SnO₂. It is possible to force the rutile structure to be formed by adding small amounts of SnO₂ (see, for example, WO93/08237).

In this embodiment preferred interference pigments have the following layer structure:

| | | | |
|---|---|---|---|
| SUB | TiO₂ | SiO₂ | TiO₂ |
| SUB | TiO₂ | SiO₂ | Fe₂O₃ |
| SUB | TiO₂ | SiO₂ | TiO₂/Fe₂O₃ |
| SUB | TiO₂ | SiO₂ | (Sn,Sb)O₂ |
| SUB | (Sn,Sb)O₂ | SiO₂ | TiO₂ |
| SUB | Fe₂O₃ | SiO₂ | (Sn,Sb)O₂ |
| SUB | TiO₂/Fe₂O₃ | SiO₂ | TiO₂/Fe₂O₃ |
| SUB | TiO₂ | SiO₂ | MoS₂ |
| SUB | TiO₂ | SiO₂ | Cr₂O₃ |
| SUB | Cr₂O₃ | SiO₂ | TiO₂ |
| SUB | Fe₂O₃ | SiO₂ | TiO₂ |
| SUB | TiO₂ | Al₂O₃ | TiO₂ |
| SUB | Fe₂TiO₅ | SiO₂ | TiO₂ |
| SUB | TiO₂ | SiO₂ | Fe₂TiO₅/TiO₂ |
| SUB | TiO suboxides | SiO₂ | TiO suboxides |
| SUB | TiO₂ | SiO₂ | TiO₂ + SiO₂ + TiO₂ + Prussian |
| | | | Blue |
| SUB | TiO₂ | SiO₂ | TiO₂ + SiO₂ + TiO₂ |
| SUB | TiO₂ + SiO₂ + TiO₂ | SiO₂ | TiO₂ + SiO₂ + TiO₂ |

wherein SUB is transparent platelet-like substrate having a low index of refraction, such as natural, or synthetic mica, SiO₂ flakes, Al₂O₃ flakes, and glass flakes.

To enhance the weather and light stability interference pigments can be, depending on the field of application, subjected to a surface treatment (protective layer). Useful surface treatments are, for example, described in DE-A-2215191, DE-A-3151354, DE-A-3235017, DE-A-3334598, DE-A-4030727, EP-A-649886, WO97/29059, WO99/57204, and U.S. Pat. No. 5,759,255. Said surface treatment might also facilitate the handling of the pigment, especially its incorporation into various application media.

Other preferred pigments are platelet-like organic pigments, such as chinacridones, phthalocyanine, fluororubine, red perylenes or diketopyrrolopyrroles. Reference is made to PCT/EP2007/061657, where a 2,9-dichloroquinacridone in platelet form showing colour flop is described.

Preferably, the pigment concentration of the tinted clear coating is from 0.002 to 10%, more preferably from 0.02 to 5%, even more preferably from 0.1 to 3%, most preferably from 0.1 to 2.5% by weight of solid binder.

The coating layers, especially the tinted clear coating layers or top coating layer can comprise further additives which can be selected from the group consisting of phenolic and aminic antioxidants, phosphites, phosphonites, benzofuranones, metal stearates, metal oxides, organophosphorus compounds, hydroxylamines, flame retardants and mixtures thereof.

Such further additives are for example:

1. Antioxidants

1.1. Alkylated monophenols, for example 2,6-di-tert-butyl-4-methylphenol, 2-tert-butyl-4,6-di-methylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethyl-phenol, 2,6-dioctadecyl-4-methylphenol, 2,4,6-tricyclohexylphenol, 2,6-di-tert-butyl-4-meth-oxymethylphenol, nonylphenols which are linear or branched in the side chains, for example, 2,6-di-nonyl-4-methylphenol, 2,4-dimethyl-6-(1′-methylundec-1-yl)phenol, 2,4-dimethyl-6-(1-methylheptadec-1′-yl)phenol, 2,4-dimethyl-6-(1′-methyltridec-1-yl)phenol and mixtures thereof.

1.2. Alkylthiomethylphenols, for example 2,4-dioctylthiomethyl-6-tert-butylphenol, 2,4-dioctyl-thiomethyl-6-methylphenol, 2,4-dioctylthiomethyl-6-ethylphenol, 2,6-di-dodecylthiomethyl-4-nonylphenol.

1.3. Hydroquinones and alkylated hydroquinones, for example 2,6-di-tert-butyl-4-methoxy-phenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl) adipate.

1.4. Tocopherols, for example α-tocopherol, β-tocopherol, γ-tocopherol, δ-tocopherol and mixtures thereof (vitamin E).

1.5. Hydroxylated thiodiphenyl ethers, for example 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)-disulfide.

1.6. Alkylidenebisphenols, for example 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)-phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butyl-phenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methyl-phenyl)-3-n-dodecylmercaptobutane, ethylene glycol bis[3,3-bis(3′-tert-butyl-4′-hydroxyphenyl)butyrate], bis(3-tert-butyl-4-hydroxy-5-methyl-phenyl)dicyclopentadiene, bis[2-(3′-tert-butyl-2′-hydroxy-5′-methylbenzyl)-6-tert-butyl-4-methylphenyl]terephthalate, 1,1-bis-(3,5-dimethyl-2-hydroxyphenyl)butane, 2,2-bis(3,5-di-tert-butyl-4-hydroxyphenyl)propane, 2,2-bis(5-tert-butyl-4-hydroxy-2-methylphenyl)-4-n-dodecylmercaptobutane, 1,1,5,5-tetra-(5-tert-butyl-4-hydroxy-2-methylphenyl)pentane.

1.7. O-, N- and S-benzyl compounds, for example 3,5,3′,5′-tetra-tert-butyl-4,4′-dihydroxydibenzyl ether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxy-benzyl)sulfide, isooctyl-3,5-di-tert-butyl-4-hydroxybenzylmercaptoacetate.

1.8. Hydroxybenzylated malonates, for example dioctadecyl-2,2-bis(3,5-di-tert-butyl-2-hydroxybenzyl)malonate, di-octadecyl-2-(3-tert-butyl-4-hydroxy-5-methylbenzyl)malonate, di-dodecylmercaptoethyl-2,2-bis(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate.

1.9. Aromatic hydroxybenzyl compounds, for example 1,3,5-tris(3,5-di-tert-butyl-4-hydroxy-benzyl)-2,4,6-trimethylbenzene, 1,4-bis(3,5-di-tert-butyl-4-hydroxybenzyl)-2,3,5,6-tetramethyl benzene, 2,4,6-tris(3,5-di-tert-butyl-4-hydroxybenzyl)phenol.

1.10. Triazine compounds, for example 2,4-bis(octylmercapto)-6-(3,5-di-tert-butyl-4-hydroxy-anilino)-1,3,5-triazine, 2-octylmercapto-4,6-bis(3,5-di-tert-butyl-4-hydroxyanilino)-1,3,5-tri-azine, 2-octylmercapto-4,6-bis(3,5-di-tert-butyl-4-hydroxyphenoxy)-1,3,5-triazine, 2,4,6-tris-(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris-(3,5-di-tert-butyl-4-hydroxyphenylethyl)-1,3,5-triazine, 1,3,5-tris(3,5-di-tert-butyl-4-hydroxy-phenylpropionyl)-hexahydro-1,3,5-triazine, 1,3,5-tris(3,5-dicyclohexyl-4-hydroxybenzyl)iso-cyanurate.

1.11. Benzylphosphonates, for example dimethyl-2,5-di-tert-butyl-4-hydroxybenzylphosphonate, diethyl-3,5-di-tert-butyl-4-hydroxybenzylphosphonate, dioctadecyl3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid.

1.12. Acylaminophenols, for example 4-hydroxylauranilide, 4-hydroxystearanilide, octyl N-(3,5-di-tert-butyl-4-hydroxyphenyl)carbamate.

1.13. Esters of β-(3,5-di-tert-butyl-4-hydroxyphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylol-propane, 4-hydroxymethyl-1-phospha-2,6,7-trioxabicyclo[2.2.2]octane.

1.14. Esters of β-(5-tert-butyl-4-hydroxy-3-methylphenyl)propionic acid with mono- or poly-hydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis-(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane; 3,9-bis[2-{3-(3-tert-butyl-4-hydroxy-5-methylphenyl)propionyloxy}-1,1-dimethylethyl]-2,4,8,10-tetraoxaspiro[5.5]-undecane.

1.15. Esters of β-(3,5-dicyclohexyl-4-hydroxyphenyl)propionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, tri-ethylene glycol, pentaerythritol, tris(hydroxyethyl)isocyanurate, N,N′-bis(hydroxyethyl)ox-amide, 3-thiaundecanol, 3-thiapentadecanol, trimethylhexanediol, trimethylolpropane, 4-hydroxymethyl-1-phospha-2,6,7-trioxabicyclo[2.2.2]octane.

1.16. Esters of 3,5-di-tert-butyl-4-hydroxyphenyl acetic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)ox-amide, 3-thiaundecanol, 3-thiapentadecanol, trimethylhexanediol, trimethylolpropane, 4-hydroxymethyl-1-phospha-2,6,7-trioxabicyclo[2.2.2]octane.

1.17. Amides of β-(3,5-di-tert-butyl-4-hydroxyphenyl)propionic acid e.g. N,N′-bis(3,5-di-tert-butyl-4-hydroxyphenylpropionyl)hexamethylenediamide, N,N′-bis(3,5-di-tert-butyl-4-hydroxy-phenylpropionyl)trimethylenediamide, N,N′-bis(3,5-di-tert-butyl-4-hydroxyphenylpropionyl)hydrazide, N,N′-bis[2-(3-[3,5-di-tert-butyl-4-hydroxyphenyl]propionyloxy)ethyl]oxamide (Naugard® XL-1, supplied by Uniroyal).

1.18. Ascorbic acid (vitamin C)

1.19. Aminic antioxidants, for example N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butyl-aminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylaminomethylphenol, 2,4′-diaminodiphenylmethane, 4,4′-diaminodiphenylmethane, N,N,N′,N′-tetra-methyl-4,4′-diaminodiphenylmethane, 1,2-bis[(2-methylphenyl)amino]ethane, 1,2-bis(phenyl-amino)propane, (o-tolyl)biguanide, bis[4-(1′,3′-dimethylbutyl)phenyl]amine, tert-octylated N-phenyl-1-naphthylamine, a mixture of mono- and dialkylated tert-butyl/tert-octyldiphenylamines, a mixture of mono- and dialkylated nonyldiphenylamines, a mixture of mono- and dialkylated dodecyldiphenylamines, a mixture of mono- and dialkylated isopropyl/isohexyl-diphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines, a mixture of mono- and dialkylated tert-octyl-phenothiazines, N-allylphenothiazine, N,N,N′,N′-tetraphenyl-1,4-diaminobut-2-ene.

2. Nickel compounds, for example nickel complexes of 2,2′-thio-bis[4-(1,1,3,3-tetramethyl-butyl)phenol], such as the 1:1 or 1:2 complex, with or without additional ligands such as n-butylamine, triethanolamine or N-cyclohexyldiethanolamine, nickel dibutyldithiocarbamate, nickel salts of the monoalkyl esters, e.g. the methyl or ethyl ester, of 4-hydroxy-3,5-di-tert-butylbenzylphosphonic acid, nickel complexes of ketoximes, e.g. of 2-hydroxy-4-methylphenylundecylketoxime, nickel complexes of 1-phenyl-4-lauroyl-5-hydroxypyrazole, with or without additional ligands.

3. Metal deactivators, for example N,N′-diphenyloxamide, N-salicylal-N′-salicyloyl hydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)oxalyl dihydrazide, N,N′-bis(salicyloyl)thiopropionyl dihydrazide.

4. Phosphites and phosphonites, for example triphenyl phosphite, diphenylalkyl phosphites, phenyldialkyl phosphites, tris(nonylphenyl) phosphite, trilauryl phosphite, trioctadecyl phosphite, distearylpentaerythritol diphosphite, tris(2,4-di-tert-butylphenyl) phosphite, diisodecyl pentaerythritol diphosphite, bis(2,4-di-tert-butylphenyl)pentaerythritol diphosphite, bis(2,4-di-cumylphenyl)pentaerythritol diphosphite, bis(2,6-di-tert-butyl-4-methylphenyl)pentaerythritol diphosphite, diisodecyloxypentaerythritol diphosphite, bis(2,4-di-tert-butyl-6-methylphenyl)-pentaerythritol diphosphite, bis(2,4,6-tris(tert-butylphenyl)pentaerythritol diphosphite, tristearyl sorbitol triphosphite, tetrakis(2,4-di-tert-butylphenyl) 4,4′-biphenylene diphosphonite, 6-isooctyloxy-2,4,8,10-tetra-tert-butyl-12H-dibenz[d,g]-1,3,2-dioxaphosphocin, bis(2,4-di-tert-butyl-6-methylphenyl)methyl phosphite, bis(2,4-di-tert-butyl-6-methylphenyl)ethyl phosphite, 6-fluoro-2,4,8,10-tetra-tert-butyl-12-methyl-dibenz[d,g]-1,3,2-dioxaphosphocin, 2,2′,2″-nitrilo-[triethyltris(3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl)phosphite, 5-butyl-5-ethyl-2-(2,4,6-tri-tert-butylphenoxy)-1,3,2-dioxaphosphirane.

The following phosphites are especially preferred:

Tris(2,4-di-tert-butylphenyl) phosphite (Irgafos® 168, Ciba Specialty Chemicals Inc.), tris(nonylphenyl) phosphite,

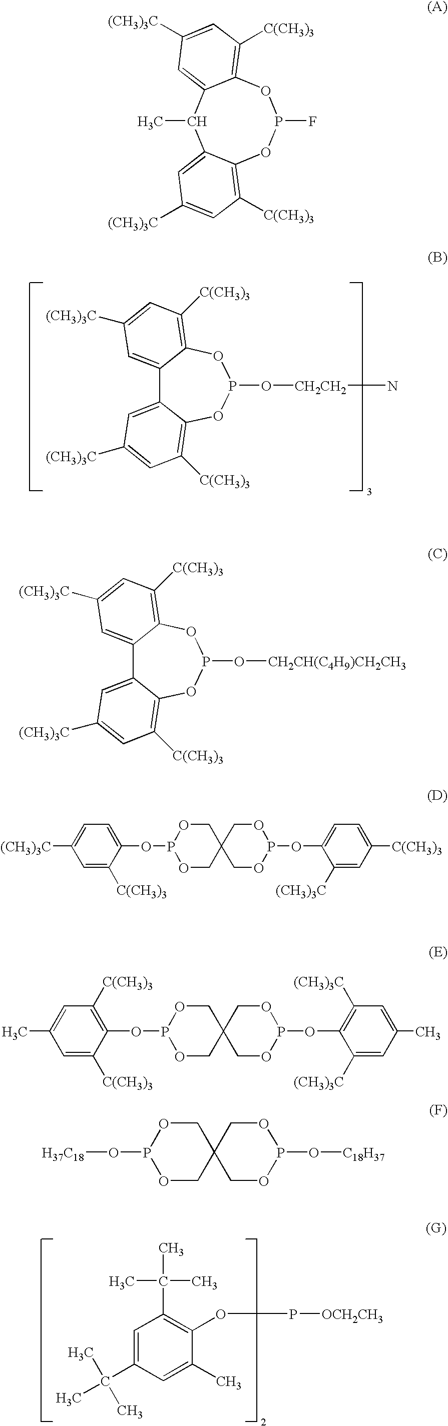

5. Hydroxylamines, for example N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine, N,N-dialkylhydroxylamine derived from hydrogenated tallow amine.

6. Nitrones, for example, N-benzyl-alpha-phenylnitrone, N-ethyl-alpha-methylnitrone, N-octyl-alpha-heptylnitrone, N-lauryl-alpha-undecylnitrone, N-tetradecyl-alpha-tridecylnnitrone, N-hexadecyl-alpha-pentadecylnitrone, N-octadecyl-alpha-heptadecylnitrone, N-hexadecyl-alpha-heptadecylnitrone, N-ocatadecyl-alpha-pentadecylnitrone, N-heptadecyl-alpha-hepta-decylnitrone, N-octadecyl-alpha-hexadecylnitrone, nitrone derived from N,N-dialkylhydroxylamine derived from hydrogenated tallow amine.

7. Thiosynergists, for example dilauryl thiodipropionate, dimistryl thiodipropionate, distearyl thiodipropionate or distearyl disulfide.

8. Peroxide scavengers, for example esters of β-thiodipropionic acid, for example the lauryl, stearyl, myristyl or tridecyl esters, mercaptobenzimidazole or the zinc salt of 2-mercapto-benzimidazole, zinc dibutyldithiocarbamate, dioctadecyl disulfide, pentaerythritol tetrakis(β-dodecylmercapto)propionate.

9. Polyamide stabilizers, for example copper salts in combination with iodides and/or phosphorus compounds and salts of divalent manganese.

10. Basic co-stabilizers, for example melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids, for example calcium stearate, zinc stearate, magnesium behenate, magnesium stearate, sodium ricinoleate and potassium palmitate, antimony pyrocatecholate or zinc pyrocatecholate.

11. Nucleating agents, for example inorganic substances, such as talcum, metal oxides, such as titanium dioxide or magnesium oxide, phosphates, carbonates or sulfates of, preferably, alkaline earth metals; organic compounds, such as mono- or polycarboxylic acids and the salts thereof, e.g. 4-tert-butylbenzoic acid, adipic acid, diphenylacetic acid, sodium succinate or sodium benzoate; polymeric compounds, such as ionic copolymers (ionomers). Especially preferred are 1,3:2,4-bis(3′,4′-dimethylbenzylidene)sorbitol, 1,3:2,4-di(paramethyl-dibenzylidene)sorbitol, and 1,3:2,4-di(benzylidene)sorbitol.

12. Fillers and reinforcing agents, for example calcium carbonate, silicates, glass fibres, glass beads, asbestos, talc, kaolin, mica, barium sulfate, metal oxides and hydroxides, car-bon black, graphite, wood flour and flours or fibers of other natural products, synthetic fibers.

13. Other additives, for example plasticisers, lubricants, emulsifiers, rheology additives, catalysts, flow-control agents, optical brighteners, flameproofing agents, antistatic agents and blowing agents.

14. Benzofuranones and indolinones, for example those disclosed in U.S. Pat. No. 4,325,863; U.S. Pat. No. 4,338,244; U.S. Pat. No. 5,175,312; U.S. Pat. No. 5,216,052; U.S. Pat. No. 5,252,643; DE-A-4316611; DE-A-4316622; DE-A-4316876; EP-A-0589839, EP-A-0591102; EP-A-1291384 or 3-[4-(2-acetoxyethoxy)phenyl]-5,7-di-tert-butylbenzofuran-2-one, 5,7-di-tert-butyl-3-[4-(2-stearoyloxy-ethoxy)phenyl]benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-di-methylphenyl)-5,7-di-tert-butylbenzofuran-2-one, 3-(3,5-dimethyl-4-pivaloyloxyphenyl)-5,7-di-tert-butylbenzofuran-2-one, 3-(3,4-dimethylphenyl)-5,7-di-tert-butylbenzofuran-2-one, 3-(2,3-dimethylphenyl)-5,7-di-tert-butylbenzofuran-2-one, 3-(2-acetyl-5-isooctylphenyl)-5-isooctyl-benzofuran-2-one.

The further additives are usually used in a concentration of 0.1-5 wt % by weight of the solid binder.

Typically, the additives (e.g. pigments, dyes, 2-hydroxyphenyl triazines, sterically hindered amine stabilizers, further additives) are dispersed in a dispersion of binder and solvent and then added to the coating composition or the additives are dispersed directly in the coating composition.

The present invention also pertains to a process for the preparation of a tinted clear coating for wood which comprises the applying of
(e) at least one un-tinted clear coating composition comprising at least one binder to a wood substrate;
(f) at least one tinted clear coating composition comprising at least one binder and at least one colorant selected from the group consisting of dyes and pigments and combinations thereof to the un-tinted clear coating layer (e);
   optionally
(g) at least one un-tinted clear coating composition comprising at least one binder to the tinted clear coating layer (f);
   and optionally
(h) at least one tinted clear coating composition comprising at least one binder and at least one colorant selected from the group consisting of dyes and pigments and combinations thereof to the un-tinted clear coating layer (g).

The preferences for (e) are as above for coating layer (a). The preferences for (f) are as above for coating layer (b). The preferences for (g) are as above for coating layer (c). The preferences for (h) are as above for coating layer (d).

In this process, the wood surface can be untreated or treated with a stain or impregnation as described above.

The preferences for this process is as described above for the tinted clear coating for wood.

All % are weight-% unless otherwise stated. All ratios are weight ratios unless otherwise stated.

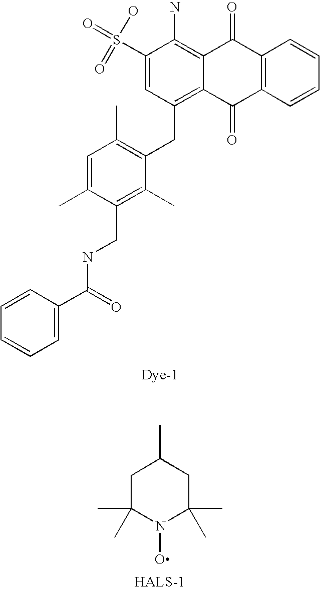

### APPLICATION EXAMPLES

### Used Accelerated Light Fastness Test DIN/ISO/EN 11341 (CAM 0)

This light fastness method is used for testing colored architectural, industrial and other paints for indoor applications.

The conditions for the test DIN/ISO/EN 11341/C(CAM 0):

| Machine type: | Atlas Weather-Ometer Ci-65 A (two-tier rack) | |
|---|---|---|
| Light Source: | 6.5 kW Xenon burner water-cooled | |
| Filter combination: | Outer filter “Sodalime” (Window glass) | |
| | Inner filter Boro S | |
| Procedure: | C | |
| Cycle conditions: | Permanent Light | |
| | 0.35 W/m²@340 nm: | Irradiance, controlled |
| | 50 (±2)° C.: | Black panel temperature |
| | 50 (±5) %: | Relative Humidity |

### Wood Panel Preparation:

All coating layers are applied either by brush or spray application. At least two coating layers are required. For smoother surfaces three layers can be applied. An impregnation or stain can additionally be applied directly to the wood surface.

### Coating Composition

TABLE 1
Polyol component of 2K PU clear coating formulation (weight %)

| | |
|---|---|
| Macrynal SM 510n (60% supply form)¹⁾ | 80.2 |
| Butylgycolacetate | 4.6 |
| Methoxypropylacetate | 14.6 |
| EFKA 3030²⁾ | 0.2 |
| EFKA 3034³⁾ | 0.2 |
| Dabco 33-LV⁴⁾ (33% catalyst) | 0.2 |
| Total polyol component | 100.0 |

TABLE 2
Isocyanate component of 2K PU clear coating formulation (weight %)

| | |
|---|---|
| Desmodur N3390⁵⁾ (90% in solvent mixture) | 60.0 |
| Butylacetate | 20.0 |
| Methoxypropylacetate | 20.0 |
| Total polyol component | 100.0 |

Raw Materials:
¹⁾Acrylic polyol resin (ca. 4.5% hydroxyl content based on solid resin); supplier: Solutia (formerly Vianova Resins); solvent: SolventNaphtha:xylene:n-butylacetate 1:2:1
²⁾Levelling agent; supplier: Ciba; 50-53% in solvent; solvent: isobutanol
³⁾Wetting agent; supplier: Ciba; 50-53% in solvent; solvent: methoxy propanol
⁴⁾Catalyst; supplier: AirProducts; solvent: dipropylene glycol
⁵⁾Aliphatic isocyanate; supplier: Bayer AG; solvent: n-butyl acetate:SolventNaphtha 1:1

Polyol and isocyanate components are mixed in a weight ratio of 2/1. Solid content is 50 wt-%.

### Pigment Composition

Pigment preparations for the tinted clear coating are prepared with a milling equipment to get optimal dispersed pigments:

TABLE 3
Pigment preparations

| | Pigment concentrations (wt- |
|---|---|
| Pigment preparation | % on preparation) |
| P-1 (C.I. Pigment Blue 15:1) | 7.6 |
| P-2 (C.I. Pigment Red 264) | 12.6 |

The panels are evaluated with colour measurement (Minolta CM 3600d spectrophotometer, specular included, parameter calculation (according to DIN 6174) with CGREC software).

### Example 1

A tinted clear coating formulation (according to invention) is applied over one layer of the clear coating formulation on wood panels and dried 30 min in the air and 30 min in a stove at 80° C. For comparison one layer of un-tinted clear coating formulation are applied over one layer of the tinted clear coating formulation on wood and dried 30 min in the air and 30 min in a stove at 80° C. The pigment concentration is 0.4 wt-% on solid content of mixed formulation.

TABLE 4
Chroma of tinted and un-tinted clear coating on birch wood

| Set-up | Used | Chroma |
|---|---|---|
| Bottom/top layer | pigment paste | C* (initial) |
| 1 x tinted/1 x un-tinted* | P-1 | 31.8 |
| 1 x un-tinted/1 x tinted | P-1 | 40.4 |
| 1 x tinted/1 x un-tinted* | P-2 | 48.3 |
| 1 x un-tinted/1 x tinted | P-2 | 57.5 |

*Comparison

Tinted clear coating panel (according to invention) shows a significantly increased chroma and an enhanced accentuation of three-dimensional structure of wood grains compared to un-tinted clear coating panel (comparison).

### Example 2

The tinted clear coating panels are produced with pigment preparation P-1 (0.4 wt-% pigment on solid content of mixed formulation) as in example 1 except that UV absorber is used additionally. The un-tinted clear coating is applied in two layers on fir wood before applying the tinted clear coating. In one set-up the wood is impregnated with sterically hindered amine HALS-1 (1 wt-% in water).

TABLE 5
Chroma and light fastness comparison of tinted clear coatings

| Impregnation | UV absorber (wt-% on | Chroma | | |
|---|---|---|---|---|
| with HALS- | solid content of mixed | C* | Chroma C* | |
| 1 (wt-% in water) | formulation) | (initial) | (500 h) | DE* |
| No | No | 38.8 | 32.9 | 9.4 |
| No | 1% HPT-8 | 36.7 | 34.7 | 2.85 |
| 1% HALS-1 | No | 37.1 | 37.1 | 0.5 |

Tinted clear coating wood panel (according to invention) which exhibit increased chroma can be stabilized to optimize light fastness, i.e. less colour deviation.

### Example 3

A tinted clear coating formulation (according to invention) is applied over two layers of the clear coating formulation on ash wood and dried overnight in the air and 30 min in a stove at 40° C. For comparison two layers of un-tinted clear coating formulation are applied over one layer of the tinted clear coating formulation on ash wood and dried overnight in the air and 30 min in a stove at 40° C. For tinting dye-1 is used, the dye concentration is 0.4 wt-% on solid content of mixed formulation.

TABLE 6
Chroma and lightness of tinted and un-tinted clear coating on ash wood

| Set-up | | |
|---|---|---|
| Bottom/top layer | Lightness L* | Chroma C* (initial) |
| 1 x tinted/2 x un-tinted* | 35.7 | 18.6 |
| 2 x un-tinted/1 x tinted | 39.3 | 24.6 |

*Comparison

Tinted clear coating panel (according to invention) shows a significantly increased chroma, an increased lightness and an enhanced accentuation of three-dimensional structure of wood grains compared to un-tinted clear coating panel (comparison).

### Example 4

A tinted clear coating formulation (according to invention) is applied over two layers of the clear coating formulation on ash wood and dried overnight in the air and 30 min in a stove at 40° C. For comparison two layers of un-tinted clear coating formulation are applied over one layer of the tinted clear coating formulation on birch wood and dried overnight in the air and 30 min in a stove at 40° C. For tinting pearlescent pigment bronze (mica type coated with iron oxide) is used, the pigment concentration is 2.0 wt-% on solid content of mixed formulation.

TABLE 7
Chroma and lightness of tinted and un-tinted clear coating on birch wood

| Set-up | | |
|---|---|---|
| Bottom/top layer | Lightness L* | Chroma C* (initial) |
| 1 x tinted/2 x un-tinted* | 60.8 | 37.3 |
| 2 x un-tinted/1 x tinted | 62.6 | 38.9 |

*Comparison

Tinted clear coating panel (according to invention) shows a significantly increased chroma, an increased lightness and an enhanced accentuation of three-dimensional structure of wood grains compared to un-tinted clear coating panel (comparison).

1. A tinted clear coating for wood, wherein the coating comprises the following layers
(a) at least one un-tinted clear coating layer adhering to a wood substrate comprising at least one binder;
(b) at least one tinted clear coating layer adhering to the un-tinted clear coating layer (a) and comprising at least one binder and at least one colorant selected from the group consisting of dyes and pigments and combinations thereof.

2. A tinted clear coating for wood according to claim 1, wherein (a) is one or two un-tinted clear coating layers and (b) is one tinted clear coating layer.

3. A tinted clear coating for wood according to claim 1, additionally comprising
(c) at least one un-tinted clear coating layer adhering to the tinted clear coating layer (b) and comprising at least one binder;
and optionally
(d) at least one tinted clear coating layer adhering to the un-tinted clear coating layer (c) and comprising at least one binder at least one colorant selected from the group consisting of dyes and pigments and combinations thereof.

4. A tinted clear coating for wood according to claim 1, wherein the wood is untreated or treated with a stain or impregnation which penetrates into pores in a surface of the wood.

5. A tinted clear coating for wood according to claim 4, wherein the stain or impregnation comprises a sterically hindered amine, a UV absorber or combinations thereof.

6. A tinted clear coating for wood according to claim 1, wherein the tinted clear coating layer (b) or the coating layer which is the outermost coating layer or both coating layers comprises a UV absorber.

7. A tinted clear coating for wood according to claim 5, wherein the UV absorber is selected from the group consisting of 2-(2-hydroxyphenyl)-1,3,5-triazines, oxamides, acrylates, esters of substituted and unsubstituted benzoic acids, 2-hydroxybenzophenones, 2-(2′-hydroxyphenyl)benzotriazoles, transparent metal oxides and combinations thereof.

8. A tinted clear coating for wood according to claim 1, wherein the dye is selected from the group consisting of solvent dyes, disperse dyes, acid dyes, reactive dyes, basic dyes, metal complex dyes and combinations thereof.

9. A tinted clear coating for wood according to claim 1, wherein the pigment is a C.I. Pigment Red 23, 101, 112, 144, 146, 166, 177, 179, 184, 185, 202, 206, 221, 254, 255, 264, a C.I. Pigment Violet 19, 23, 37, a C.I. Pigment Blue 15, 15:1, 15:2, 15:3, 15:4, 15:6, 16, 60, a C.I. Pigment Yellow 13, 17, 34, 42, 74, 83, 93, 109, 110, 128, 129, 139, 184, a C.I. Pigment Green 7, 36, a C.I. Pigment Orange 48, 73, a diketo-pyrrolo-pyrrol pigment, a quinacridone pigment, an interference pigment; as well as mixtures, crystal combinations or solid solutions thereof.

10. A process for the preparation of a tinted clear coating for wood which comprises applying to a surface of the wood
(e) at least one un-tinted clear coating composition comprising at least one binder to a wood substrate;
(f) at least one tinted clear coating composition comprising at least one binder and at least one colorant selected from the group consisting of dyes and pigments and combinations thereof to the un-tinted clear coating layer (e);
optionally
(g) at least one un-tinted clear coating composition comprising at least one binder to the tinted clear coating layer (f);
and optionally
(h) at least one tinted clear coating composition comprising at least one binder and at least one colorant selected from the group consisting of dyes and pigments and combinations thereof to the un-tinted clear coating layer (g).

11. A tinted clear coating for wood according to claim 6, wherein the UV absorber is selected from the group consisting of 2-(2-hydroxyphenyl)-1,3,5-triazines, oxamides, acrylates, esters of substituted and unsubstituted benzoic acids, 2-hydroxybenzophenones, 2-(2′-hydroxyphenyl)benzotriazoles, transparent metal oxides and combinations thereof.

12. A tinted clear coating for wood according to claim 3, wherein the tinted clear coating layer (b) or the coating layer which is the outermost coating layer or both coating layers comprises a UV absorber.

13. A tinted clear coating for wood according to claim 13, wherein the UV absorber is selected from the group consisting of 2-(2-hydroxyphenyl)-1,3,5-triazines, oxamides, acrylates, esters of substituted and unsubstituted benzoic acids, 2-hydroxybenzophenones, 2-(2′-hydroxyphenyl)benzotriazoles, transparent metal oxides and combinations thereof.

14. A tinted clear coating for wood according to claim 3, wherein the wood is untreated or treated with a stain or impregnation which penetrates into the pores in a surface of the wood.

15. A process for the preparation of a tinted clear coating for wood according to claim 10 wherein the wood is treated with a stain or impregnation which penetrates into pores in a surface of the wood.
